(19) United States
(12) Patent Application Publication
(10) Pub. No.: US 2025/0357635 A1
(43) Pub. Date: Nov. 20, 2025

(54) ELECTRIC POWER STORAGE MODULE

(71) Applicant: KABUSHIKI KAISHA TOYOTA JIDOSHOKKI, Kariya-shi, Aichi (JP)

(72) Inventors: Yuki OKAMOTO, Kariya-shi, Aichi (JP); Shintaro YAMAOKA, Kariya-shi, Aichi (JP); Fumihiko ISHIGURO, Kariya-shi, Aichi (JP); Takayuki HIROSE, Kariya-shi, Aichi (JP)

(73) Assignee: KABUSHIKI KAISHA TOYOTA JIDOSHOKKI, Kariya-shi, Aichi (JP)

(21) Appl. No.: 18/860,985

(22) PCT Filed: Apr. 20, 2023
(86) PCT No.: PCT/JP2023/015783

§ 371 Date: Oct. 28, 2024

(30) Foreign Application Priority Data
May 2, 2022 (JP) 2022-075934

(51) Int. Cl. H01M 50/474; H01G 11/80; H01M 4/02; H01M 50/46

(52) U.S. Cl. CPC H01M 50/474; H01M 50/46; H01G 11/80; H01M 2004/029

(57) ABSTRACT

An electric power storage module including an electrode stack, a sealing body provided with the electrode stack, and a frame member formed separately from the sealing body and bonded to the sealing body, in which the sealing body includes a welded end part formed by welding of end portions of sealing members and spacers, and communication holes having openings on an outer surface of the welded end part, the frame member includes frame parts surrounding the openings of the communication holes, each frame part has a first end surface bonded to the outer surface to surround each opening and a second end surface serving as an end surface opposite to the first end surface and formed to surround each opening.

### TECHNICAL FIELD

The present disclosure relates to an electric power storage module.

### BACKGROUND ART

Patent Literature 1 has described an electric power storage module. This electric power storage module includes an electrode stack including a plurality of electrodes stacked with a separator interposed therebetween, and a sealing body disposed to surround the electrode stack. The sealing body includes a first resin part provided in a peripheral edge portion of an electrode plate and a second resin part provided outside a plurality of the first resin parts to surround the first resin parts. The sealing body is provided with a plurality of communication holes communicating with internal spaces that are separated from each other and formed between the electrodes. Each communication hole is used, for example, to supply an electrolytic solution to each internal space. A plurality of communication hole regions in which the same number of the communication holes are provided are formed at one of four wall parts constituting the sealing body. In this electric power storage module, the electrolytic solution is supplied to the internal spaces while a nozzle tip surface of an electrolytic solution supply device is pressed against the communication hole region of the sealing body by a packing. In this case, the packing is strongly compressed at a plurality of ridges provided in the communication hole region to surround each of the communication holes.

Patent Literature 2 has described an electric power storage module. This electric power storage module includes an electrode stack including a plurality of electrodes stacked with a separator interposed therebetween, a frame disposed to surround the electrode stack, and a pressure regulating valve attached to the frame. The frame includes a first sealing part provided on a peripheral edge portion of an electrode plate and a second sealing part provided on an outer surface of the first sealing part. One wall part constituting the frame is provided with a plurality of attachment regions, in each region where the pressure regulating valve is attached. In each attachment region, the frame is provided with a communication hole communicating with an internal space formed between the electrodes. The communication hole is used, for example, to supply an electrolytic solution to the internal space. In this electric power storage module, the communication holes can be sealed by attaching the pressure regulating valves to the attachment regions. The frame is provided with frame-shaped protrusions in the attachment regions, which are used to bond with the pressure regulating valves through thermal welding.

### CITATION LIST

### Patent Literature

Patent Literature 1: Japanese Unexamined Patent Publication No. 2020-035665
Patent Literature 2: Japanese Unexamined Patent Publication No. 2021-009795

### SUMMARY OF INVENTION

### Technical Problem

In Patent Literatures 1 and 2, the ridge and protrusion frame-shaped are formed together with the second resin part and the second sealing part by injection molding. As a specific example, a stack including electrode plates, which are stacked and provided with first sealing parts, is placed in a mold for injection molding, and subjected to insert molding by injection of a resin to form frame-shaped protrusions together with a second sealing part. At this step, the resin injected into the mold flows to the entire outer surface including openings of communication holes of the first sealing parts. As a result, a defect of blocking the communication holes by the resin may occur, leading to a decrease in reliability.

An object of the present disclosure is to provide an electric power storage module capable of avoiding a deterioration in reliability.

### Solution to Problem

An electric power storage module according to the present disclosure includes: an electrode stack including a plurality of electrodes configured to be stacked along a first direction, each electrode including a current collector and an active material layer formed on the current collector; a sealing body provided on the electrode stack to form an internal space between current collectors adjacent to each other and seal the internal space; an electrolytic solution contained in the internal space; and a frame member formed separately from the sealing body and bonded to the sealing body, in which the sealing body includes a plurality of sealing members provided on respective peripheral edge portions of a plurality of the current collectors, each sealing member having a frame shape, a plurality of spacers, each of which is interposed between the plurality of sealing members adjacent to each other in the first direction to form the internal space between the current collectors together with the sealing members, a weld end part formed by welding of end portions of the plurality of sealing members and the plurality of spacers, the end portions being formed opposite to the internal space, and a plurality of communication holes communicating with each of a plurality of the internal spaces and having openings on an outer surface of the welded end part at an opposite side to the internal spaces, each of the frame member includes a plurality of frame parts surrounding the openings of the communication holes as viewed from a second direction intersecting the outer surface, and each of the plurality of frame parts includes a first end surface bonded to the outer surface to surround each opening of the plurality of communication holes as viewed from the second direction, and a second end surface serving as an end surface opposite to the first end surface and formed to surround each opening of the plurality of communication holes as viewed from the second direction.

In this electric power storage module, the sealing body provided with the electrode stack is provided with the communication holes communicating with the internal spaces containing an electrolytic solution between the current collectors of the electrodes. The sealing body includes the welded end part welded to the end portions of the sealing members and spacers, in which the sealing members are provided on the peripheral edge portions of the current collectors, and each spacer is interposed between the sealing members. The openings of the communication holes described above are formed on the outer surface of this welded end part. The sealing body is provided with the frame member including the frame parts, each surrounding the opening of each communication hole on the outer surface of the welded end part. Therefore, for example, the frame member can be used to perform the sealing with a nozzle pressed during the filling of the electrolytic solution or can be used to bond another member to the sealing body. In this electric power storage module, the frame member is formed separately from the sealing body and bonded to the sealing body at a portion surrounding the opening of each communication hole of the outer surface. According to this, unlike a case where the frame member is integrally formed with the sealing body by injection molding, a defect such as the blocking of each communication hole by a resin for injection molding hardly occurs. Therefore, a decrease in reliability is avoided.

In the electric power storage module according to the present disclosure, the frame member further includes a flange configured to protrude from an end portion at the first end surface side of each of the plurality of frame parts and be bonded to the outer surface. According to this configuration, for example, in a case where the nozzle or the other component of the electrolytic solution filling machine is pressed against the frame member or a case where another member is bonded to the frame member, the stress applied to the end surface of the frame member is dispersed in the frame parts and the flanges, resulting in the reduction of the stress applied to the sealing body side. Therefore, as compared to the case where the frame member does not have the flanges, it is possible to minimize a sealing or bonding defect by an increase in the surface pressure applied to the end surface of the frame member while a damage of the structure on the sealing body side is minimized.

In the electric power storage module according to the present disclosure, the flanges protrude from the frame part toward the inside of the region surrounded by the frame part as viewed from the second direction. In this case, it is possible to obtain the above-described effect of including the flanges, with the outer dimension of the frame member maintained.

The electric power storage module according to the present disclosure further includes a plurality of the frame members arranged along a third direction intersecting the first direction and the second direction and serving as a direction along the outer surface, the plurality of the frame members are disposed to surround each of groups of the openings different from each other, the groups of the openings being arranged along the first direction as viewed from the second direction and surrounded by the plurality of frame parts, and the flange protrudes from each frame part along the third direction. As described above, it is possible to reliably reduce the stress applied to the sealing body side by using the plurality of frame members to provide the flange on each frame member.

In addition, in the electric power storage module according to the present disclosure, the frame members include at least two frame parts having different sizes in the first direction, thereby forming an asymmetric shape in the first direction. In this case, the positions of the regions surrounded by the frame parts in the first direction can be varied between a case where one frame member is disposed such that one of two frame parts having different sizes in the first direction faces closer to one side (for example, an upper side) in the first direction than the other and a case where the other frame member is disposed in the reverse direction. Therefore, the openings of the communication holes having different positions in the first direction can be surrounded by a smaller number of types of the frame members (that is, while the number of components is reduced) without interference.

In the electric power storage module according to the present disclosure, the sealing body may be made of a resin, and the frame member may be made of a resin containing a base compound identical to that of the resin of the sealing body and having a melting point higher than a melting point of the resin of the sealing body. In this case, for example, in a case where the frame member is bonded to the sealing body by welding, the deformation of the frame member caused by contraction is minimized.

### Advantageous Effects of Invention

According to the present disclosure, it is possible to provide the electric power storage module capable of improving reliability.

### BRIEF DESCRIPTION OF DRAWINGS

FIG. 1 is a schematic cross-sectional view illustrating an electric power storage module according to the present embodiment.

FIG. 2 is a schematic sectional view illustrating a part of the electric power storage module illustrated in FIG. 1.

FIG. 3 is a schematic side view illustrating the electric power storage module illustrated in FIG. 1.

FIG. 4 is a schematic sectional view illustrating a plurality of examples of a frame member illustrated in FIG. 1.

FIG. 5 is a schematic sectional view for explaining one step of a method for manufacturing the electric power storage module illustrated in FIGS. 1 to 4.

FIG. 6 is a schematic sectional view for explaining one step of the method for manufacturing the electric power storage module illustrated in FIGS. 1 to 4.

FIG. 7 is a schematic plan view illustrating a frame member according to a modification.

FIG. 8 is a schematic cross-sectional view illustrating the frame member illustrated in FIG. 7.

FIG. 9 is a view illustrating a step of providing the frame member illustrated in FIGS. 7 and 8.

FIG. 10 is a view illustrating a step of providing the frame member illustrated in FIGS. 7 and 8.

### DESCRIPTION OF EMBODIMENTS

Hereinbelow, an embodiment will be described in detail with reference to the drawings. In the description of the drawings, the same or equivalent elements will be denoted by the same reference signs, and a repeated description may not be repeated. It is illustrated as an orthogonal coordinate system defined by a coordinate axis indicating a first direction D1, a coordinate axis indicating a second direction D2, and a coordinate axis indicating a third direction D3.

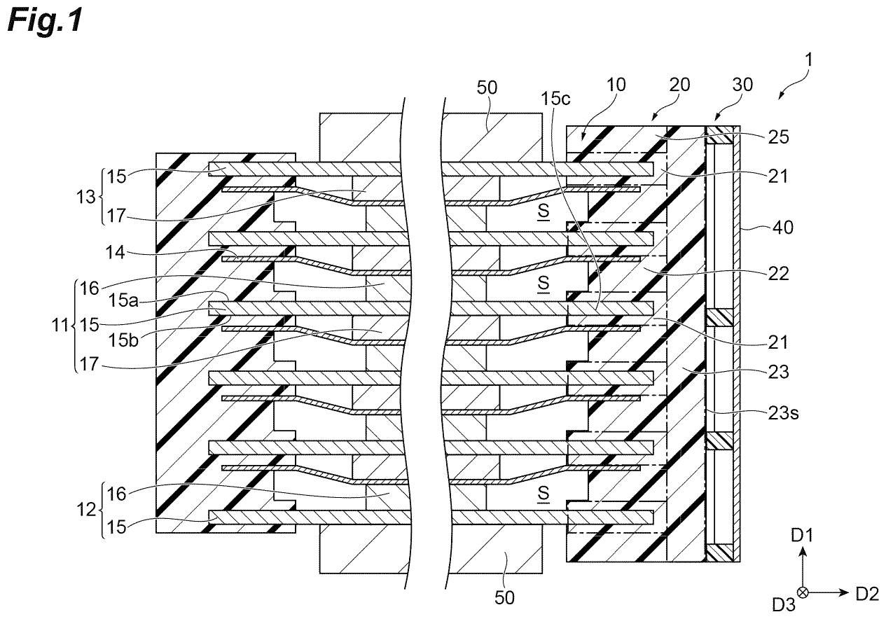

FIG. 1 is a schematic cross-sectional view illustrating an electric power storage module according to the present embodiment. An electric power storage module 1 illustrated in FIG. 1 is an electric power storage module used for batteries of various vehicles such as forklift trucks, hybrid vehicles, and electric vehicles, for example. The electric power storage module 1 is, for example, a secondary battery such as a nickel-hydrogen secondary battery or a lithium-ion secondary battery. The electric power storage module 1 may be an electric double-layer capacitor or an all-solid-state battery. Herein, a case of the electric power storage module 1 configured as a lithium-ion secondary battery will be illustrated.

The electric power storage module 1 includes an electrode stack 10, a sealing body 20, a frame member 30, and a sheet member 40. The electrode stack 10 includes a plurality of electrodes stacked along a first direction D1. The first direction D1 is a direction in which the electrodes are stacked and is a height direction of the electric power storage module 1. The electrodes include a plurality of bipolar electrodes 11, a positive terminal electrode 12, and a negative terminal electrode 13. A separator 14 is interposed between the electrodes adjacent to each other. The electrode stack 10 is formed with the bipolar electrodes 11 being stacked between the positive terminal electrode 12 and the negative terminal electrode 13.

Each bipolar electrode 11 includes a current collector 15, a positive electrode active material layer 16, and a negative electrode active material layer 17. The current collector 15 has, for example, a rectangular sheet shape. The current collector 15 includes a first principal surface 15a serving as one surface and a second principal surface 15b serving as the other surface opposite to the first principal surface 15a. That is, the current collector 15 has the first principal surface 15a and the second principal surface 15b, which face directions opposite to each other in the stacking direction D. The positive electrode active material layer 16 is provided on a first principal surface 15a of the current collector 15. The negative electrode active material layer 17 is provided on the second principal surface 15b of the current collector 15. The bipolar electrodes 11 are stacked such that the positive electrode active material layer 16 of one bipolar electrode 11 and the negative electrode active material layer 17 of another bipolar electrode 11 face each other. The first principal surface 15a of the current collector 15 herein is a surface facing one side in the first direction D1, and the second principal surface 15b of the current collector 15 is a surface facing the other side in the first direction D1.

The positive electrode active material layer 16 and the negative electrode active material layer 17 have a rectangular shape as viewed from the first direction D1. The negative electrode active material layer 17 is slightly larger than the positive electrode active material layer 16 as viewed from the first direction D1. That is, in plan view viewed from the first direction D1, the entire region where the positive electrode active material layer 16 is formed is positioned within a region where the negative electrode active material layer 17 is formed.

The positive terminal electrode 12 includes a current collector 15 and a positive electrode active material layer 16 provided on a first principal surface 15a of the current collector 15. The positive terminal electrode 12 does not include a positive electrode active material layer 16 and a negative electrode active material layer 17 on the second principal surface 15b of the current collector 15. That is, an active material layer is not provided on the second principal surface 15b of the current collector 15 of the positive terminal electrode 12. The second principal surface 15b of the current collector 15 of the positive terminal electrode 12 serves as a positive electrode terminal surface of the electric power storage module 1. The positive terminal electrode 12 is stacked over a bipolar electrode 11 at one end portion of the electrode stack 10 in the first direction D1. The positive terminal electrode 12 is stacked over the bipolar electrode 11 such that the positive electrode active material layer 16 of the positive terminal electrode 12 faces a negative electrode active material layer 17 of the bipolar electrode 11.

The negative terminal electrode 13 includes a current collector 15 and a negative electrode active material layer 17 provided on a second principal surface 15b of the current collector 15. The negative terminal electrode 13 does not include a positive electrode active material layer 16 and a negative electrode active material layer 17 on the first principal surface 15a of the current collector 15. That is, an active material layer is not provided on the first principal surface 15a of the current collector 15 of the negative terminal electrode 13. The first principal surface 15a of the current collector 15 of the negative terminal electrode 13 serves as a negative electrode terminal surface of the electric power storage module 1. The negative terminal electrode 13 is stacked over a bipolar electrode 11 at the other end portion of the electrode stack 10 in the first direction D1. That is, the negative terminal electrode 13 is disposed on the opposite side to the positive terminal electrode 12 with respect to the bipolar electrodes 11. The negative terminal electrode 13 is stacked over the bipolar electrode 11 such that the negative electrode active material layer 17 of the negative terminal electrode 13 faces a positive electrode active material layer 16 of the bipolar electrode 11.

The individual separators 14 are disposed between the bipolar electrodes 11 adjacent to each other in the first direction D1, between the positive terminal electrode 12 and the bipolar electrode 11, and between the negative terminal electrode 13 and the bipolar electrode 11. The separator 14 is interposed between the positive electrode active material layer 16 and the negative electrode active material layer 17. The separator 14 separates the positive electrode active material layer 16 from the negative electrode active material layer 17 to allow charge carriers such as lithium ions to pass while a short-circuit caused by the contact between adjacent electrodes is avoided.

The current collector 15 is a chemically inactive electric conductor that causes a current to continuously flow through the positive electrode active material layer 16 and the negative electrode active material layer 17 during discharge or charge of a lithium-ion secondary battery. A material of the current collector 15 is, for example, a metal material, a conductive resin material, a conductive inorganic material, or other materials. Examples of the conductive resin material include a resin obtained by adding a conductive filler to a conductive polymer material or a non-conductive polymer material as necessary. The current collector 15 may include a plurality of layers. In this case, each layer of the current collector 15 may contain the above-described metal material or conductive resin material.

A covering layer may be formed on a surface of the current collector 15. The covering layer may be formed by a known method such as plating or spray coating. The current collector 15 may have, for example, a plate shape, a foil shape (for example, metal foil), a film shape, a mesh shape, or other shapes. Examples of the metal foil include an aluminum foil, a copper foil, a nickel foil, a titanium foil, and a stainless steel foil. The current collector 15 may be formed by the integration of alloy foils composed of the above-described metals or a plurality of the above-described metal foils in a bonding manner. In a case where the current collector 15 has a foil shape, a thickness of the current collector 15 may be, for example, 1 μm to 100 μm. For example, some of the current collectors 15 among the current collector 15 in the bipolar electrode 11, the positive terminal electrode 12, and the negative terminal electrode 13 may have a thickness of 100 μm or more. In this case, the structural stability of the electrode stack 10 is enhanced.

The positive electrode active material layer 16 contains a positive electrode active material capable of adsorption and desorption of charge carriers such as lithium ions. Examples of the positive electrode active material include a lithium composite metal oxide having a stratified rock salt type structure, a metal oxide having a spinel structure, and a polyanionic compound. The positive electrode active material may be any material that can be used for the lithium-ion secondary battery. The positive electrode active material layer 16 may contain a plurality of the positive electrode active materials. In the present embodiment, the positive electrode active material layer 16 contains olivine type lithium iron phosphate (LiFePO₄) as a composite oxide.

The negative electrode active material layer 17 contains a negative electrode active material capable of adsorption and desorption of charge carriers such as lithium ions. The negative electrode active material may be any of a simple substance, an alloy, or a compound. Examples of the negative electrode active material include Li, carbon, a metal compound, and other materials. The negative electrode active material may be an element that can be alloyed with lithium, a compound thereof, or other materials. Examples of the carbon include natural graphite, artificial graphite, hard carbon (non-graphitizing carbon), soft carbon (graphitizing carbon), and other carbon materials. Examples of the artificial graphite include highly oriented graphite, meso-carbon microbeads, and other artificial graphite. Examples of the element that can be alloyed with lithium include silicon, tin, and other elements. In the present embodiment, the negative electrode active material layer 17 contains graphite as a carbon-based material.

Each of the positive electrode active material layer 16 and the negative electrode active material layer 17 (hereinafter, also simply referred to as the “active material layer” in some cases) may further contain a conductive aid, a binder, an electrolyte (polymer matrix, ion conductive polymer, electrolytic solution, or other electrolytes) for enhancing electric conductivity, a supporting electrolyte salt (lithium salt) for enhancing ion conductivity, and other components as necessary. The conductive aid is added to enhance the conductivity of each of electrodes (the bipolar electrodes 11, the positive terminal electrode 12, and the negative terminal electrode 13). The conductive aid is, for example, acetylene black, carbon black, graphite, or other materials.

Examples of the binder include fluorine-containing resins such as polyvinylidene fluoride, polytetrafluoroethylene, and fluororubber, thermoplastic resins such as polypropylene and polyethylene, imide resins such as polyimide and polyamideimide, alkoxysilyl group-containing resins, acrylic resins such as acrylic acid and methacrylic acid, alginates such as styrene-butadiene rubber (SBR), carboxymethyl cellulose, sodium alginate, and ammonium alginate, water-soluble cellulose ester crosslinked bodies, starch-acrylic acid graft polymers, and other binders. The binder thereof can be used alone or in combination. For example, water, N-methyl-2-pyrrolidone (NMP) or the other solvent is used as a solvent.

The separator 14 may be, for example, a porous sheet or a nonwoven fabric containing a polymer that absorbs and holds an electrolyte. Examples of materials of the separator 14 include polypropylene, polyethylene, polyolefin, polyester, and other materials. The separator 14 may have a single layer structure or a multilayer structure. The multilayer structure may have, for example, a ceramic layer or the other layer as an adhesive layer or a heat resistant layer. The separator 14 may be impregnated with an electrolyte. The separator 14 may include an electrolyte such as a polymer electrolyte or an inorganic electrolyte. Examples of the electrolyte with which the separator 14 is impregnated include a liquid electrolyte (electrolytic solution) containing a nonaqueous solvent and an electrolyte salt dissolved in a nonaqueous solvent, or a polymer gel electrolyte containing an electrolyte held in a polymer matrix.

In a case where the separator 14 is impregnated with the electrolytic solution, a known lithium salt such as LiClO₄, LiAsF₆, LiPF₆, LiBF₄, LiCF₃SO₃, LiN(FSO₂)₂, or LiN(CF₃SO₂)₂ may be used as the electrolyte salt. In addition, known solvents such as cyclic carbonates, cyclic esters, chain carbonates, chain esters, and ethers may be used as the nonaqueous solvent. Note that, two or more of these known solvent materials may be used in combination.

The sealing body 20 is formed in a frame shape at a peripheral edge portion of the electrode stack 10 to surround the electrode stack 10. The sealing body 20 can be bonded to each of the first principal surface 15a and the second principal surface 15b of the current collector 15, at the peripheral edge portion 15c of each current collector 15. The sealing body 20 is provided to form internal spaces S between the adjacent current collectors 15 in the first direction D1, and seal each internal space S. An electrolytic solution (not illustrated) is contained in each internal space S. That is, the sealing body 20 defines the internal spaces S that contain the electrolytic solution together with the adjacent current collectors 15 in the first direction D1. The sealing body 20 blocks the permeation of the electrolytic solution to the outside.

The sealing body 20 controls intrusion of moisture, gas, and other substances from the outside of the electrode stack 10 into the internal spaces S, and controls leakage of the electrolyte included in the electrode stack 10 to the outside. An edge portion of the separator 14 is bonded to the sealing body 20. The sealing body 20 includes an insulating material. Examples of materials of the sealing body 20 include various resin materials such as polypropylene, polyethylene, polystyrene, ABS resin, acid-modified polypropylene, acid-modified polyethylene, acrylonitrile styrene resin, and other materials.

The sealing body 20 includes a plurality of sealing members 21, a plurality of spacers 22, and a welded end part 23. Each sealing member 21 is provided on each current collector 15. Therefore, the sealing members 21 are stacked over one another along the first direction D1. The sealing member 21 is frame-shaped and provided at the peripheral edge portion 15c of the current collector 15. That is, the sealing member 21 is provided to reach from the first principal surface 15a of the current collector 15 to the second principal surface 15b of the current collector 15 through an end surface of the current collector 15, and covers the peripheral edge portion 15c. The sealing member 21 can be welded to at least one of the first principal surface 15a or the second principal surface 15b of the current collector 15.

The spacer 22 is disposed to be interposed between the sealing members 21 adjacent to each other in the first direction D1. Accordingly, the spacer 22 holds a space between the sealing members 21 adjacent to each other in the first direction D1, that is, between the current collectors 15 adjacent to each other in the first direction D1. The spacer 22 has a frame shape with an inner peripheral end surface and an outer peripheral end surface, and is disposed over the peripheral edge portion 15c of the current collector 15 as viewed in the first direction D1. Here, an end portion of the separator 14 is sandwiched and secured between the sealing member 21 and the spacer 22. The end portion of the separator 14 can be welded to at least one of the sealing member 21 and the spacer 22.

The welded end part 23 is welded to and integrated with end portions of the sealing members 21 and end portions of the spacers 22, those end portions being disposed on the opposite side to the internal spaces S. More specifically, a part of the sealing members 21 and a part of the spacers 22 are welded to each other to form the welded end part 23, the sealing members 21 and the spacers 22 being positioned further outward than the current collectors 15 as viewed from the first direction D1. The welded end part 23 has a frame shape to surround the electrode stack 10 as viewed from the first direction D1. The welded end part 23 has an outer surface 23s on the opposite side to the internal spaces S, which extends along the first direction D1 and serves an outer surface of the sealing body 20.

The sealing body 20 includes weld overlay parts 25. The weld overlay parts 25 are disposed on respective outer surfaces in the first direction D1 of the sealing members 21 provided on the current collectors 15 of the positive terminal electrode 12 and the negative terminal electrode 13. The weld overlay parts 25 are bonded to the sealing members 21. End portions of the weld overlay parts 25 positioned further outward than the current collectors 15 as viewed from the first direction D1 are welded to end portions of the sealing members 21 to constitute part of the welded end part 23. The sealing body 20 has a polygonal outer shape as viewed from the first direction D1, and includes individual sides of the polygon. For example, in a case where the outer shape of the sealing body 20 is a quadrangle as viewed from the first direction D1, the sealing body 20 includes four sides. A communication hole 27 described later is provided at one side of the sides of the sealing body 20. The weld overlay part 25 herein is provided on the side alone where the communication hole 27 is provided.

Conductive members 50 functioning as a terminal for extracting a current from the electric power storage module 1 are disposed on and electrically connected to a portion of the first principal surface 15a of the current collector 15 of the positive terminal electrode 12 and a portion of the second principal surface 15b of the current collector 15 of the negative terminal electrode 13 each, the portions being exposed from the sealing body 20. The conductive members 50 can be used to electrically connect the electric power storage modules 1. In addition, the conductive members 50 can also be used as a restraining member in order to apply a restraining load to the electrode stack 10. Furthermore, a cooling flow path may be formed in each conductive member 50. The electrode stack 10 can be cooled by circulating a cooling medium through the cooling flow path formed in each conductive member 50.

The frame member 30 is formed separately from the sealing body 20 and bonded to the sealing body 20. The frame member 30 herein is bonded (for example, welded) to the outer surface 23s of the welded end part 23 serving as the outer surface of the sealing body 20. The frame member 30 extends from one weld overlay part 25 (a weld overlay part 25 on the positive terminal electrode 12 side) to the other weld overlay part 25 (a weld overlay part 25 on the negative terminal electrode 13 side) in the first direction D1. Therefore, the outer edges of the frame member 30 in the first direction D1 are positioned on the weld overlay parts 25 and coincides with the outer edges of the weld overlay parts 25, as an example. The sheet member 40 is bonded (attached) to an end surface 30s of the frame member 30 disposed opposite to the sealing body 20. The sheet member 40 is, for example, a laminate film. Next, details of the frame member 30 will be described.

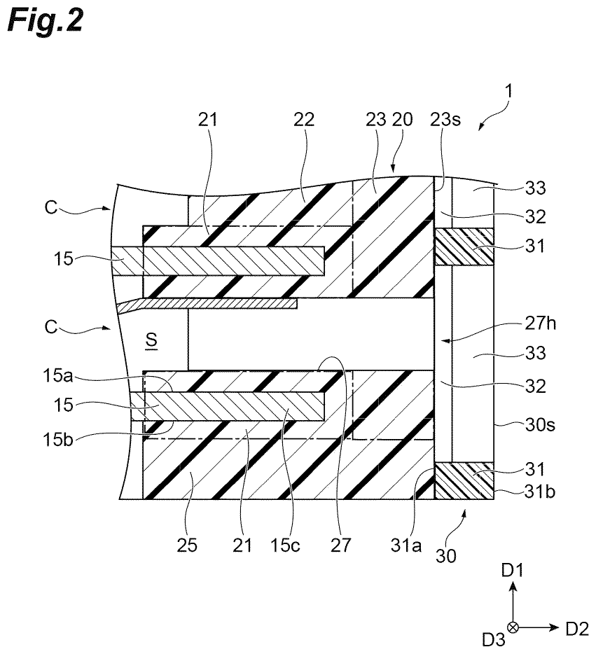

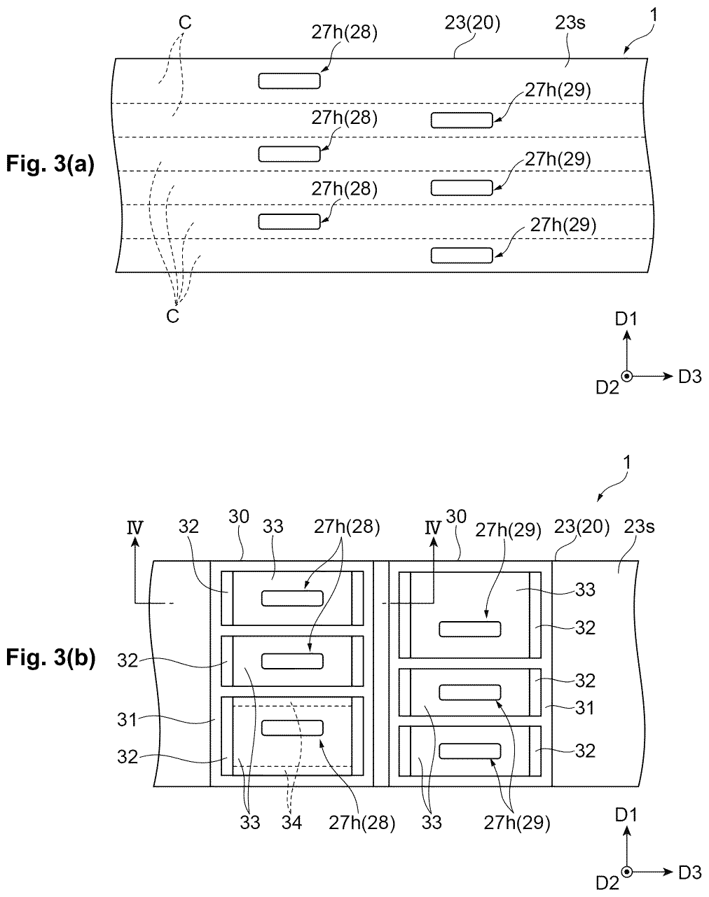

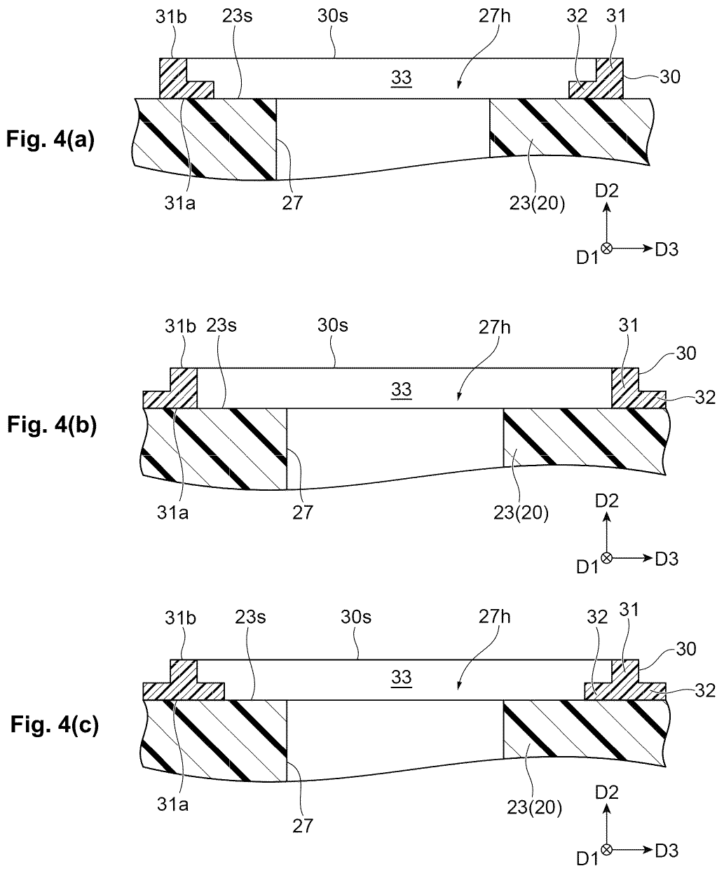

FIG. 2 is a schematic sectional view illustrating a part of the electric power storage module illustrated in FIG. 1. FIG. 3 is a schematic side view illustrating the electric power storage module illustrated in FIG. 1. FIG. 4(a) is a schematic sectional view taken along line IV-IV of FIG. 3. FIG. 3(a) illustrates a state in which the frame member 30 is not provided on the sealing body 20, and FIG. 3(b) illustrates a state in which the frame member 30 is provided on the sealing body 20. As illustrated in FIGS. 2, 3, and 4(a), the communication holes 27 communicating with the respective internal spaces S are formed in the sealing body 20.

As an example, the communication hole 27 is formed by cutting out a part of the spacer 22, and is formed to penetrate the spacer 22 and the welded end part 23. Each communication hole 27 has an opening at one side, which is opened to each internal space S, and an opening 27h at the other side, which is opened to the outer surface 23s of the welded end part 23. In the electric power storage module 1, a pair of the current collectors 15 adjacent to each other form a cell C including one internal space S. One communication hole 27 herein is formed for one cell C. As viewed from a second direction D2 intersecting (orthogonal to) the outer surface 23s (see FIG. 3(a)), the openings 27h of the communication holes 27 are arranged such that positions in a third direction D3 are different for each cell C. The third direction D3 is a direction intersecting with the first direction D1 and the second direction D2, and is a width direction of the electric power storage module 1 along the outer surface 23s.

As an example, the openings 27h in the third direction D3 are positioned in a staggered manner from the cell C on one end side to the cell C on the other end side in the first direction D1. Therefore, a plurality of the openings 27h herein at the substantially same positions in the third direction D3 are provided corresponding to every other cell C and arranged along the first direction D1. In other words, the openings 27h herein include a group of openings 28 arranged along the first direction D1 as viewed from the second direction D2, and another group of openings 29 arranged along the first direction D1 at positions separated from the openings 28 in the third direction D3.

The frame member 30 is bonded (for example, welded) to the outer surface 23s of the welded end part 23. The frame member 30 includes a plurality of frame parts 31 surrounding the respective openings 27h of a plurality of the communication holes 27 as viewed from the second direction D2. A plurality of the frame members 30 are used herein. The frame members 30 are arranged apart from each other along the third direction D3. Each of the frame parts 31 of one frame member 30 is provided to surround each opening 28 in the group, and each of the frame parts 31 of another frame member 30 is provided to surround each opening 29 in the group. That is, the frame members 30 are disposed to surround the group of the openings 28 and the group of the openings 29 each, by using the frame parts 31, the openings 28 and 29 serving as the openings 27h in the different groups from each other and being arranged in the first direction D1 as viewed from the second direction D2.

Each frame part 31 includes a first end surface 31a bonded (for example, welded) to the outer surface 23s to surround each opening 27h of the communication holes 27 as viewed from the second direction D2, and a second end surface 31b serving as an end surface opposite to the first end surface 31a and formed to surround each opening 27h of the communication holes 27 as viewed from the second direction D2. Each frame member 30 further includes flanges 32, each protruding from an end portion at the first end surface 31a side of the frame part 31 along the outer surface 23s and being bonded (for example, welded) to the outer surface 23s. The frame parts 31 herein have a rectangular frame shape. Therefore, a region 33 surrounded by each frame part 31 as viewed from the second direction D2 has a rectangular shape. A bottom surface of this region 33 includes the outer surface 23s of the welded end part 23 (the outer surface of the sealing body 20). In this example, the flanges 32 protrude along the third direction D3 from portions extending along the first direction D1 of the frame part 31 toward the inside of the region 33 surrounded by the frame part 31, as viewed from the second direction D2. As viewed from the second direction D2, the flanges 32 in each region 33 are formed to be spaced from the opening 27h (that is, the flanges 32 do not reach the opening 27h).

On the other hand, as illustrated in FIG. 4(b), the flanges 32 may protrude along the third direction D3 from the portions extending along the first direction D1 of the frame part 31 toward the outside of the region 33 surrounded by the frame part 31. Alternatively, as illustrated in FIG. 4(c), the flanges 32 may be provided to protrude toward both the inside and outside of the region 33 surrounded by the frame part 31. Furthermore, as illustrated in FIG. 3(b), for each frame member 30, other flanges 34 may be provided to protrude along the first direction D1 from portions extending along the third direction D3 of the frame part 31 toward the inside of the region 33 surrounded by the frame part 31. In this case, as viewed from the second direction, the flanges 34 in each region 33 are also formed to be spaced from the opening 27h (that is, the flanges 34 do not reach the opening 27h).

FIGS. 2 to 4 are referred to again. In one frame member 30, a plurality of (three in the illustrated example) the regions 33 arranged along the first direction D1 are partitioned by the frame parts 31, and an opening 27h of a communication hole 27 is positioned in each region 33 as viewed from the second direction. In addition, each frame member 30 has an end surface 30s (second end surface 31b) at the opposite side to the outer surface 23s of the welded end part 23 (that is, the opposite side to the sealing body 20). Therefore, as described later, the internal spaces S can be filled with the electrolytic solution from the communication holes 27 connected to the regions 33 through the openings 27h by the introduction of the electrolytic solution into each region 33 from a nozzle, with the nozzle of an electrolytic solution filling machine being in close contact with this end surface 30s.

The sheet member 40 is bonded (for example, attached) to the end surface 30s to seal the region 33 (that is, the internal space S). In the electric power storage module 1, one sheet member 40 may be provided over the frame members 30, or one sheet member 40 may be provided for each frame member 30.

Here, as illustrated in FIG. 3(b), the frame members 30 include at least two frame parts 31 having different sizes in the first direction D1, thereby forming an asymmetric shape in the first direction D1. For one frame member 30 herein, the size of one frame part 31 (that is, the region 33) of the three frame parts 31 in the first direction D1 is larger than the sizes of the other two frame parts 31 (that is, the regions 33) in the first direction D1.

Such asymmetric frame members 30 are arranged in a different orientation (reversed in the first direction D1). Accordingly, the positions of the regions 33 surrounded by the frame parts 31 in the first direction D1 are different in the frame members 30 facing different directions. As a result, the openings 27h of the communication holes 27 at different positions in the first direction D1 can be surrounded by a smaller number of types of the frame members 30.

The frame members 30 as described above can be formed of a resin having a melting point higher than the melting point of the resin of the sealing body 20. In addition, as the resin of the sealing body 20 and the resin of the frame members 30, resins containing base compounds identical to each other can be used. As an example, in a case where the sealing body 20 is formed of low density polyethylene, the frame members 30 can be formed of high density polyethylene. Provided that the sealing body 20 is formed of a plurality of resins, the phrase that the frame members 30 can be formed of a resin having a melting point higher than the melting point of the resin of the sealing body 20 can include a case where the frame members 30 are formed of a resin having a melting point higher than the melting point of at least one resin among the resins used to form the sealing body 20. As an example, in a case where the sealing member 21 of the sealing body 20 is formed of low density polyethylene, and the spacer 22 and the weld overlay part 25 are formed of high density polyethylene, the frame member 30 can be formed of high density polyethylene.

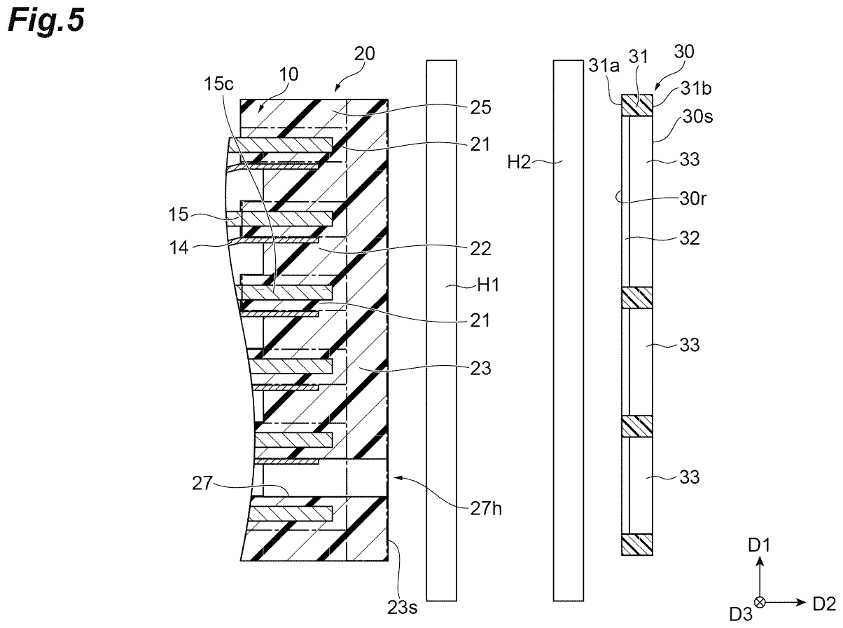

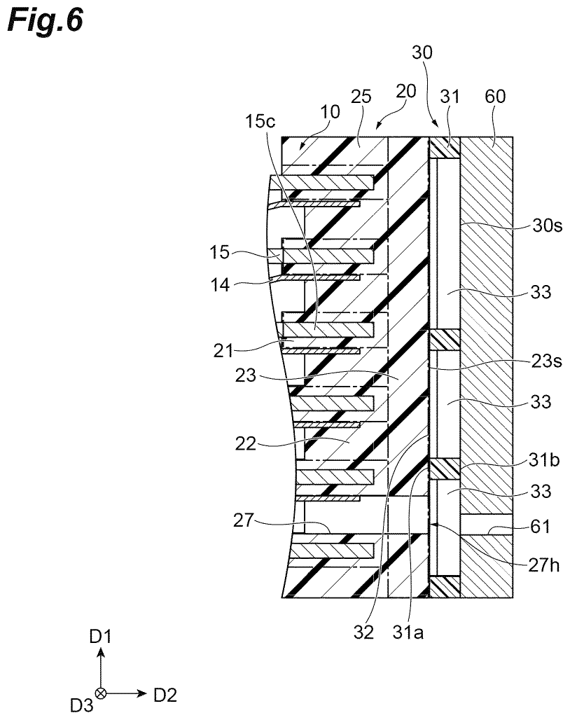

Subsequently, a method for manufacturing the electric power storage module 1 will be described. FIGS. 5 and 6 are schematic sectional views for explaining one step of a method for manufacturing the electric power storage module illustrated in FIGS. 1 to 4. As illustrated in FIG. 5, the electrode stack 10 and the sealing body 20, and the frame member 30 are separately prepared. The sealing body 20 is provided on and integrated with the electrode stack 10. In FIGS. 5 and 6, only a part of the electrode stack 10 and the sealing body 20 is illustrated.

Subsequently, a heater H1 is disposed on the outer surface of the sealing body 20 (the outer surface 23s of the welded end part 23). In addition, a heater H2 is disposed on an end surface 30r (first end surface 31a), which is the opposite side to the end surface 30s of the frame member 30. The heater H1 has a temperature lower than that of the heater H2. Subsequently, the sealing body 20 is heated by the heater H1 to melt a part of the sealing body 20 from the outer surface 23s side. In addition, the frame member 30 is heated by the heater H2 to melt a part of the frame member 30 from the end surface 30r side. At this time, as an example, by employing an infrared heater as the heater H1 and a hot plate heater as the heater H2, the sealing body 20 can be melted to a position relatively deep from the outer surface 23s while the vicinity of the end surface 30r of the frame member 30 is specifically and selectively melted.

Subsequently, as illustrated in FIG. 6, in a state in which a part of the sealing body 20 on the outer surface 23s side and a part of the frame member 30 on the end surface 30r side are melted, the frame member 30 is pressed against the sealing body 20 to be in a state in which the part of the sealing body 20 on the outer surface 23s side and the part of the frame member 30 on the end surface 30r side are melted and mixed with each other. Accordingly, the frame member 30 is welded to the sealing body 20.

Subsequently, a nozzle 60 of an electrolytic solution filling machine is brought into close contact with and pressed against the end surface 30s of the frame member 30 to introduce the electrolytic solution into the regions 33 of the frame member 30 from a filling port 61 of the nozzle 60. As a result, the internal space S of each cell C is filled with the electrolytic solution from the communication hole 27 connected to each region 33 through the opening 27h of the sealing body 20. Thereafter, the nozzle 60 is removed from the end surface 30s of the frame member 30, and the sheet member 40 is attached to the end surface 30s to seal the regions 33. Accordingly, the internal spaces S in which the electrolytic solution is disposed are sealed to manufacture the electric power storage module 1.

As described above, in the electric power storage module 1, the sealing body 20 provided with the electrode stack 10 is provided with the communication holes 27 communicating with the internal spaces S containing the electrolytic solution between the current collectors 15 of the electrodes. The sealing body 20 includes the welded end part 23 that is welded to the end portions of the sealing members 21 and spacers 22, in which each sealing member 21 is provided on the peripheral edge portion 15c of the current collector 15, and each spacer 22 is interposed between the sealing members 21. The openings 27h of the communication holes 27 are formed on the outer surface 23s of this welded end part 23. The sealing body 20 is provided with the frame member 30 including the frame parts 31 surrounding the openings 27h of the communication holes 27 on the outer surface 23s of the welded end part 23.

Therefore, for example, the frame member 30 can be used to perform the sealing with the nozzle 60 pressed during the filling of the electrolytic solution or can be used to bond another member to the sealing body 20. In this electric power storage module 1, the frame member 30 is formed separately from the sealing body 20 and bonded to the sealing body 20 at portions surrounding the openings 27h of the communication holes 27 of the outer surface 23s. According to this, unlike a case where the frame member 30 is integrally formed with the sealing body 20 by injection molding, a defect such as the blocking of each communication hole 27 by a resin for injection molding hardly occurs. Therefore, a decrease in reliability is avoided.

In addition, in the electric power storage module 1, the frame member 30 further includes the flanges 32, each protruding from an end portion on the first end surface 31a side of each of the frame parts 31 along the outer surface 23s and being bonded to the outer surface 23s. Therefore, for example, in a case where the nozzle 60 or the other component of the electrolytic solution filling machine is pressed against the frame member 30 or a case where another member is bonded to the frame member 30, the stress applied to the end surface 30s of the frame member 30 is dispersed in the frame parts 31 and the flanges 32, resulting in the reduction of the stress applied to the sealing body 20 side. Therefore, as compared to the case where the frame member 30 does not have the flanges 32, it is possible to minimize a sealing or bonding defect by an increase in the surface pressure applied to the end surface 30s of the frame member 30 while a damage of the structure on the sealing body 20 side is minimized.

In addition, in the electric power storage module 1, the flanges 32 protrude from the frame part 31 toward the inside of the region 33 surrounded by the frame part 31 as viewed from the second direction D2. Therefore, it is possible to obtain the above-described effect of including the flanges 32, with the outer dimension of the frame member 30 maintained.

In addition, the electric power storage module 1 includes the frame members 30 arranged along the third direction D3 intersecting with the first direction D1 and the second direction D2 along the outer surface 23s. The respective frame members 30 are disposed to surround the group of the openings 28 and the group of the openings 29, by using the frame parts 31, the openings 28 and 29 serving as the openings 27h in the different groups from each other and being arranged along the first direction D1 as viewed from the second direction D2. The flanges 32 protrude from the frame part 31 along the third direction D3. As described above, it is possible to reliably reduce the stress applied to the sealing body 20 side by using the plurality of frame members 30 to provide the flanges 32 on each of the frame members 30.

In addition, in the electric power storage module 1, the frame members 30 include at least two frame parts 31 having different sizes in the first direction D1, thereby including the frame members 30 having an asymmetric shape in the first direction D1. Therefore, the positions of the regions 33 surrounded by the frame parts 31 in the first direction D1 can be varied between a case where one frame member 30 is disposed such that one of two frame parts 31 having different sizes in the first direction D1 faces closer to one side (for example, an upper side) in the first direction D1 than the other and a case where the other frame member 30 is disposed in the reverse direction. Therefore, the openings 27h of the communication holes 27 having different positions in the first direction D1 can be surrounded by a smaller number of types of the frame members 30 (that is, while the number of components is reduced) without interference between the frame parts 31 and the openings 27h.

Furthermore, in the electric power storage module 1, the sealing body 20 is made of a resin, and the frame members 30 are made of a resin having a melting point higher than a melting point of the resin of the sealing body 20. In addition, as the resin of the frame members 30, a resin containing a base compound identical to a base compound of the sealing body 20 can be used. Accordingly, for example, in a case where the frame members 30 are bonded to the sealing body 20 by welding, the sealing body 20 to be bonded can be melted at a lower temperature. Therefore, in a case where the frame members 30 are pressed against the sealing body 20, the frame members 30 are not heated to a higher temperature, and the deformation of the frame member due to thermal expansion and contraction is avoided.

The above embodiment describes one aspect of the electric power storage module according to the present disclosure. Therefore, the electric power storage module according to the present disclosure is not limited to the above-described electric power storage module 1, and can be modified in any way.

For example, in the above-described embodiment, the case where the frame members 30 are welded to the sealing body 20 has been described, but as a method for bonding the frame members 30 to the sealing body 20, a known method such as adhesion using an adhesive can also be used. That is, in the electric power storage module 1, the frame members 30 formed separately from the sealing body 20 are sufficient to be bonded to the sealing body 20.

In addition, in the above-described embodiment, the aspect in which the frame members 30 include the flanges 32 has been described, but the flanges 32 are not necessary. In addition, the frame members 30 are not limited to have an asymmetric shape in the first direction D1, and may have a symmetrical shape in the first direction D1. Furthermore, each frame member 30 may include three or more frame parts 31 having different sizes in the first direction D1.

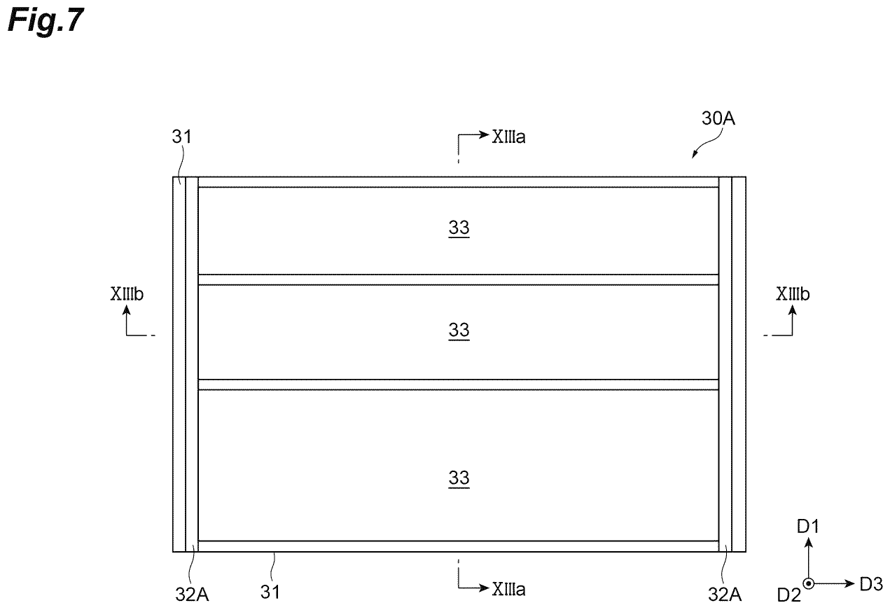

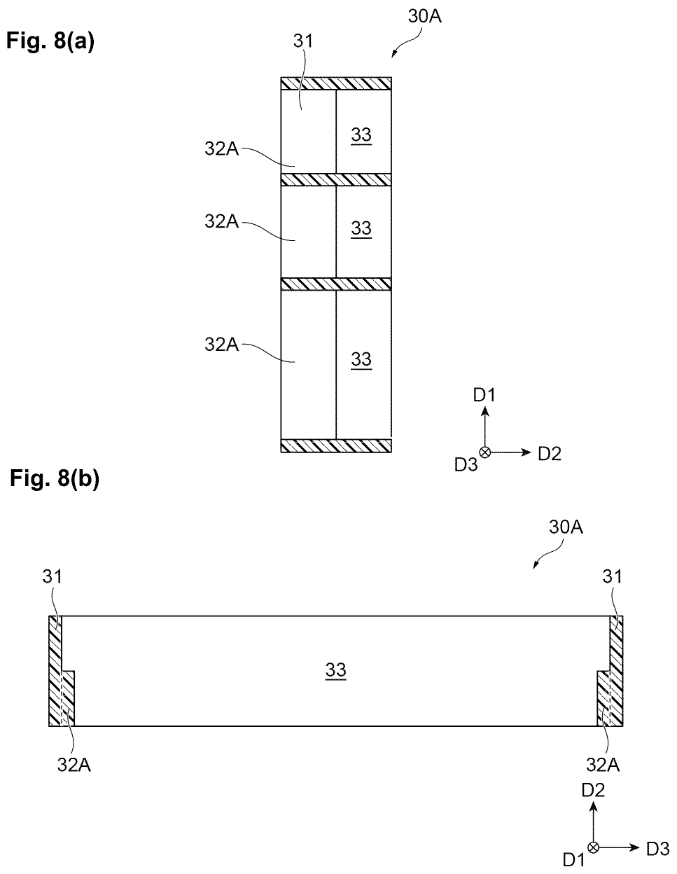

FIG. 7 is a schematic plan view illustrating a frame member according to a modification. FIG. 8 is a schematic cross-sectional view illustrating the frame member illustrated in FIG. 7. FIG. 8(a) is a cross-sectional view taken along line XIIIa-XIIIa in FIG. 7, and FIG. 8(b) is a cross-sectional view taken along line XIIIb-XIIIb in FIG. 7. The electric power storage module 1 can include a frame member 30A illustrated in FIGS. 7 and 8 instead of the frame member 30 according to the above-described embodiment. The frame member 30A is different from the frame member 30 according to the above-described embodiment in that a flange 32A is provided instead of the flange 32, and other points are the same. The flange 32A is different from the flange 32 in that a ratio of a length along a height direction (second direction D2) of a frame part 31 to a protrusion amount (thickness) from the frame part 31 is increased (herein, longer than the flange 32 in the second direction D2), and is formed in an elongated shape in the second direction D2. Such a flange 32A is also regarded as a thick portion formed to be relatively thick in the frame part 31.

Although FIGS. 7 and 8 illustrate an example in which the flanges 32A protrude toward the inside of the region 33 surrounded by the frame part 31 as an example of the flanges 32A, the flanges 32A may be provided to protrude toward the outside of the region 33 surrounded by the frame part 31 as in the flanges 32 illustrated in FIGS. 4(b) and 4(c), or may be provided to protrude toward both the inside and the outside of the region 33.

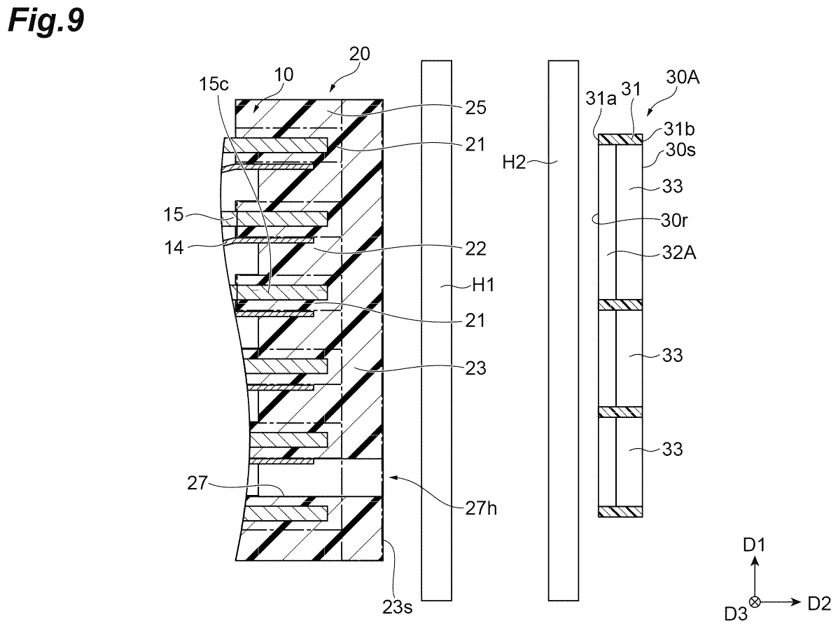

In a case where the frame member 30A as described above is provided on the sealing body 20, first, as illustrated in FIG. 9, a heater H1 is disposed on the outer surface (the outer surface 23s of the welded end part 23) side of the sealing body 20. In addition, a heater H2 is disposed on an end surface 30r (first end surface 31a), which is the opposite side to an end surface 30s of the frame member 30A. Subsequently, the sealing body 20 is heated by the heater H1 to melt a part of the sealing body 20 from the outer surface 23s side. In addition, the frame member 30A is heated by the heater H2 to melt a part of the frame member 30 from the end surface 30r side. At this time, as an example, by employing an infrared heater as the heater H1 and a hot plate heater as the heater H2, the sealing body 20 can be melted to a position relatively deep from the outer surface 23s while the vicinity of the end surface 30r of the frame member 30A is specifically and selectively melted.

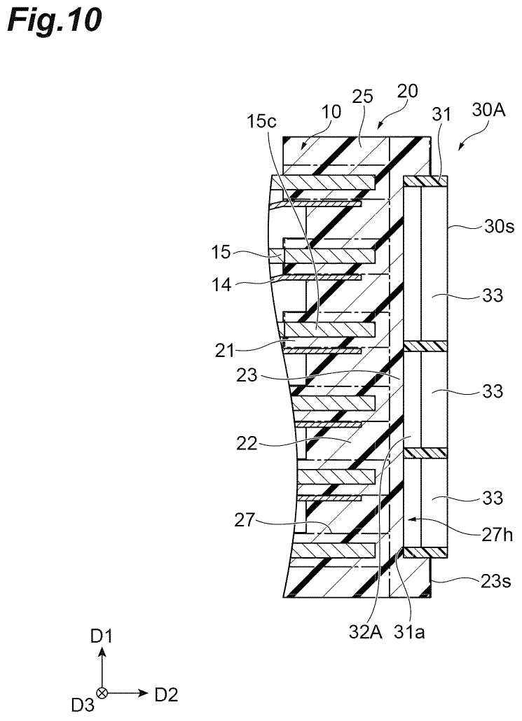

Subsequently, as illustrated in FIG. 10, in a state in which a part of the sealing body 20 on the outer surface 23s side and a part of the frame member 30A on the end surface 30r side are melted, the frame member 30A is pressed against the sealing body 20 to press the frame member 30A toward the inside of the sealing body 20 from the outer surface 23s side of the sealing body 20. In the example illustrated in the figure, the entire flanges 32A serving as a thick portion of the frame member 30A are inserted into the welded end part 23, and the flanges 32A and the welded end part 23 are melted and mixed with each other. Therefore, after this step, the portions of the frame parts 31 of the frame member 30A excluding the flanges 32A protrude from the outer surface 23s of the sealing body 20. On the other hand, when the frame member 30A is pressed against the outer surface 23s side of the sealing body 20, a part of the flanges 32A may be merely inserted into the welded end part 23. In this case, the remaining part of the flanges 32A protrudes from the outer surface 23s of the sealing body 20.

In the case where the frame member 30A is used as described above, the following effects can be obtained in addition to the effects similar to the use of the frame member 30 according to the above-described embodiment. That is, for the use of the frame member 30A, a front end portion (at least a part of the flange 32A) of the frame member 30A is inserted into the welded end part 23 of the sealing body 20, and the front end portion of the frame member 30A and the sealing body 20 are melted and mixed with each other when the frame member 30A is welded to the sealing body 20. Therefore, the front end portion of the frame member 30A and the welded end part 23 can be reliably and airtightly welded.

In addition, in a case where the front end portion of the frame member having no thick portion is pressed against the welded end part 23, the front end portion of the frame member may be deformed. However, since the frame member 30A is provided with the flanges 32A as a thick portion, the deformation of the front end portion is minimized when the front end portion of the frame member 30A is pressed against the welded end part 23. In the frame member 30A, a relatively large force is applied to the side portions of the sealing members 21 and the spacers 22 along the stacking direction (first direction D1) because of lateral pressure into the sealing members 21 and the spacers 22. Thus, it is effective to form the flanges 32 as a thick portion on deformable portions to obtain reinforcement.

Hereinbelow, the present embodiment will be additionally described. The electric power storage module according to the present disclosure includes [1] “an electric power storage module including: an electrode stack including a plurality of electrodes configured to be stacked along a first direction, each electrode including a current collector and an active material layer formed on the current collector; a sealing body provided on the electrode stack to form an internal space between the current collectors adjacent to each other and seal the internal space; an electrolytic solution contained in the internal space; and a frame member formed separately from the sealing body and bonded to the sealing body, in which the sealing body includes a plurality of sealing members provided on respective peripheral edge portions of a plurality of the current collectors, each sealing member having a frame shape, a plurality of spacers, each of which is interposed between the plurality of sealing members adjacent to each other in the first direction to form the internal space between the current collectors together with the sealing members, a welded end part formed by welding of end portions of the plurality of sealing members and the plurality of spacers, the end portions being formed opposite to the internal space, and a plurality of communication holes communicating with each of a plurality of the internal spaces and having openings on an outer surface of the welded end part at an opposite side to the internal spaces, each of the frame member includes a plurality of frame parts surrounding the openings of the communication holes as viewed from a second direction intersecting the outer surface, and each of the plurality of frame parts includes a first end surface bonded to the outer surface to surround each opening of the plurality of communication holes as viewed from the second direction, and a second end surface serving as an end surface opposite to the first end surface and formed to surround each opening of the plurality of communication holes as viewed from the second direction”.

The electric power storage module according to the present disclosure may include [2] “the electric power storage module according [1], in which the frame member further includes a flange configured to protrude along the outer surface from an end portion at the first end surface of each of the plurality of frame parts and be bonded to the outer surface”.

The electric power storage module according to the present disclosure may include [3] “the electric power storage module according [2], in which the flange protrudes from the frame part toward an inside of a region surrounded by the frame part as viewed from the second direction.

The electric power storage module according to the present disclosure may include [4] “the electric power storage module according [2] or [3], further including a plurality of the frame members arranged along a third direction intersecting the first direction and the second direction and serving as a direction along the outer surface, the plurality of the frame members are disposed to surround respective groups of the openings different from each other, the groups of the openings being arranged along the first direction as viewed from the second direction and surrounded by the plurality of frame parts, and the flange protrudes from the frame part along the third direction”.

The electric power storage module according to the present disclosure may include [5] “the electric power storage module according [4], in which the plurality of the frame members includes at least two frame parts having different sizes in the first direction to form an asymmetric shape in the first direction.

The electric power storage module according to the present disclosure may include [6] “the electric power storage module according any one of [1] to [5], in which the sealing body is made of a resin, and the frame member is made of a resin containing a base compound identical to that of the resin of the sealing body and having a melting point higher than a melting point of the resin of the sealing body.

### REFERENCE SIGNS LIST

1 Electric power storage module
10 Electrode stack
11 Bipolar electrode (electrode)
12 Positive terminal electrode (electrode)
13 Negative terminal electrode (electrode)
15 Current collector
16 Positive electrode active material layer (active material layer)
17 Negative electrode active material layer (active material layer)
20 Sealing body
21 Sealing member
22 Spacer
23 Welded end part
23s Outer surface
27 Communication hole
27h Opening
30, 30A Frame member
30s End surface
31 Frame part
31a First end surface
31b Second end surface
32, 32A Flange
33 Region
D1 First direction
D2 Second direction
D3 Third direction
S Internal space

1. An electric power storage module comprising:
an electrode stack including a plurality of electrodes configured to be stacked along a first direction, each electrode including a current collector and an active material layer formed on the current collector;
a sealing body provided on the electrode stack to form an internal space between the current collectors adjacent to each other and seal the internal space;
an electrolytic solution contained in the internal space; and
a frame member formed separately from the sealing body and bonded to the sealing body, wherein
the sealing body includes
a plurality of sealing members provided on respective peripheral edge portions of a plurality of the current collectors, each sealing member having a frame shape,
a plurality of spacers, each of which is interposed between the plurality of sealing members adjacent to each other in the first direction to form the internal space between the current collectors together with the sealing members,
a welded end part formed by welding of end portions of the plurality of sealing members and the plurality of spacers, the end portions being formed opposite to the internal space, and
a plurality of communication holes communicating with each of a plurality of the internal spaces and having openings on an outer surface of the welded end part at an opposite side to the internal spaces,
the frame member includes a plurality of frame parts surrounding the respective openings of the communication holes as viewed from a second direction intersecting the outer surface, and
each of the plurality of frame parts includes
a first end surface bonded to the outer surface to surround each opening of the plurality of communication holes as viewed from the second direction, and
a second end surface serving as an end surface opposite to the first end surface and formed to surround each opening of the plurality of communication holes as viewed from the second direction.

2. The electric power storage module according to claim 1, wherein
the frame member further includes a flange configured to protrude along the outer surface from an end portion at the first end surface of each of the plurality of frame parts and be bonded to the outer surface.

3. The electric power storage module according to claim 2, wherein
the flange protrudes from the frame part toward an inside of a region surrounded by the frame part as viewed from the second direction.

4. The electric power storage module according to claim 2, further comprising
a plurality of the frame members arranged along a third direction intersecting the first direction and the second direction and serving as a direction along the outer surface,
each of the plurality of the frame members is disposed to surround groups of the openings different from each other, the groups of the openings being arranged along the first direction as viewed from the second direction and surrounded by the plurality of frame parts, and
the flange protrudes from the frame part along the third direction.

5. The electric power storage module according to claim 4, wherein
a plurality of the frame members includes at least two frame parts having different sizes in the first direction to form an asymmetric shape in the first direction.

6. The electric power storage module according to claim 1, wherein
the sealing body is made of a resin, and
the frame member is made of a resin containing a base compound identical to that of the resin of the sealing body and having a melting point higher than a melting point of the resin of the sealing body.
